(19) United States
(12) Patent Application Publication
(10) Pub. No.: US 2006/0255781 A1
(43) Pub. Date: Nov. 16, 2006

(54) Constant voltage power supply

(76) Inventor: Kohzoh Itoh, Hyogo (JP)

Correspondence Address: COOPER & DUNHAM, LLP, 1185 AVENUE OF THE AMERICAS, NEW YORK, NY, 10036, US

(21) Appl. No.: 10/544,913

(22) PCT Filed: Dec. 24, 2004
(86) PCT No.: PCT/JP04/19751

§ 371 Date: Aug. 10, 2005

(30) Foreign Application Priority Data
Dec. 26, 2003 (JP) 2003-433774

(51) Int. Cl. G05F 1/00

(52) U.S. Cl. 323/280; 323/284

(57) ABSTRACT

A constant voltage power supply for supplying power to a load that switches between an active state and a standby state is disclosed. The constant voltage power supply includes first and second constant voltage circuits different in transient response and current consumption. The input of each of the first and second constant voltage circuits is connected to the input terminal of the constant voltage power supply, and the output of each of the first and second constant voltage circuits is connected to the output terminal of the constant voltage power supply. A switching signal generation circuit outputs a switching signal so as to cause the first operational amplifier to operate when the load is in the active state, and to cause the second operational amplifier to operate when the load is in the standby state.

### TECHNICAL FIELD

The present invention relates generally to constant voltage power supplies, and more particularly to a constant voltage power supply supplying power to a load that switches between an active state and a standby state.

### BACKGROUND ART

A constant voltage power supply that has a constant voltage circuit to supply stable voltage is employed as a power supply for, for instance, cellular phones. The constant voltage power supply has a constant voltage circuit that consumes a large amount of current (a high-speed constant voltage circuit) in order to improve power supply rejection ratio (PSRR), or ripple rejection, and load transient response. Accordingly, when the constant voltage power supply is applied to an apparatus whose load has an active mode (active state) and a sleep mode (standby state), such as a cellular phone, the amount of unnecessarily consumed current is increased in the sleep mode, which does not require high PSRR and load transient response. Therefore, consideration may be given of a constant voltage power supply having a high-speed constant voltage circuit and a constant voltage circuit that is inferior in PSRR and load transient response but reduces current consumption (a low-speed voltage circuit), the constant voltage power supply having the function of switching the constant voltage circuits based on the state of the load. In the low-speed constant voltage circuit, PSRR and load transient response are reduced because of reduced current consumption, but no problem is caused when the load is in the sleep mode.

Japanese Laid-Open Patent Application No. 2001-117650 discloses a constant voltage power supply having a high-speed constant voltage circuit and a low-speed constant voltage circuit. FIG. 1 is a circuit diagram illustrating this constant voltage power supply. A constant voltage circuit 21 is provided to stably supply power from a power supply 1 to a load 3 such as a cellular phone. The power supply 1 is connected to an input terminal (Vbat) 23 provided to the constant voltage circuit 21. The input terminal 23 is connected to an output terminal (Vout) 27 through an output transistor (DRV) 25 composed of a p-channel MOS transistor. In the constant voltage circuit 21, a high-speed voltage stabilization part 29a that consumes a large amount of current but has good PSRR and load transient response, and a low-speed voltage stabilization part 29b that has inferior PSRR and load transient response but consumes less current are provided in parallel. A transistor size employed in the high-speed voltage stabilization part 29a is greater in current supply capacity than that employed in the low-speed voltage stabilization part 29b. In this case, the high-speed voltage stabilization part 29a and the low-speed voltage stabilization part 29b have the same circuit configuration, but are different in response performance because of the difference in magnitude between currents supplied to respective operational amplifiers 33a and 33b thereof. The high-speed voltage stabilization part 29a is quicker in response than the low-speed voltage stabilization part 29b.

The high-speed voltage stabilization part 29a includes the operational amplifier 33a. The output terminal of the operational amplifier 33a is connected to the gate of the output transistor 25 through a switch part 37a provided to the constant voltage circuit 21. A reference voltage is applied to the inverting input terminal of the operational amplifier 33a from a reference voltage part (Vref) 31a. A divided voltage obtained by dividing the output voltage of the output transistor 25 between voltage-dividing resistors R1 and R2 is applied to the non-inverting input terminal of the operational amplifier 33a. Power to the operational amplifier 33a and the reference voltage part 31a is supplied from the power supply 1. An n-channel MOS transistor serving as an interruption circuit 35a that performs ON/OFF control of through current is provided between ground and each of the operational amplifier 33a, the reference voltage part 31a, and the ground-side terminal of the resistor R2.

The low-speed voltage stabilization part 29b, which has the same configuration as the high-speed voltage stabilization part 29a, includes a reference voltage part 31b, the operational amplifier 33b, an interruption circuit 35b, and resistors R3 and R4 corresponding to the reference voltage part 31a, the operational amplifier 33a, the interruption circuit 35a, and the resistors R1 and R2, respectively, of the high-speed voltage stabilization part 29a. The output terminal of the operational amplifier 33b is connected to the gate of the output transistor 25 through a switch part 37b provided to the constant voltage circuit 21. The operational amplifier 33b consumes less current than the operational amplifier 33a, so that the low-speed voltage stabilization part 29b is inferior to the high-speed voltage stabilization part 29a in PSRR and load transient response.

A switching logic circuit (SWITCHING LOGIC) 39 that outputs switching signals to the switch parts 37a and 37b is connected to the load 3. The switch parts 37a and 37b control connection and disconnection between the output terminals of the respective operational amplifiers 33a and 33b and the gate electrode of the output transistor 25. When high-level switching signals are input to the switch parts 37a and 37b, the switch parts 37a and 37b connect the output terminals of the respective operational amplifiers 33a and 33b to the gate electrode of the output transistor 25. When low-level switching signals are input to the switch parts 37a and 37b, the switch parts 37a and 37b disconnect the output terminals of the respective operational amplifiers 33a and 33b from the gate electrode of the output transistor 25. The switching logic circuit 39 is also connected to the interruption circuits 35a and 35b. The switching logic circuit 39 controls the operations of the interruption circuits 35a and 35b in accordance with signal inputs to the switch parts 37a and 37b, respectively. In this constant voltage power supply, the constant voltage circuit 21 indicated by a broken line is formed on a single chip. The high-speed voltage stabilization part 29a and the output transistor 25 form a first constant voltage circuit, and the low-speed voltage stabilization part 29b and the output transistor 25 form a second constant voltage circuit.

Next, a description is given of the operation of the conventional constant voltage power supply. When the load 3 is in an active mode (active state), the switching logic circuit 39 outputs a high-level switching signal to the switch part 37a and the interruption circuit 35a, and a low-level switching signal to the switch part 37b and the interruption circuit 35b. As a result, the switch part 37a and the interruption circuit 35a are connected so as to turn on the high-speed voltage stabilization part 29a, and the switch part 37b and the interruption circuit 35b are disconnected so as to turn off the low-speed voltage stabilization part 29b (standby state). Consequently, the voltage applied to the gate electrode of the output transistor 25 is controlled by the high-speed voltage stabilization part 29a. The amount of current consumed by the low-speed voltage stabilization part 29b in its standby state is less than or equal to 1 μA.

When the load 3 is in a sleep mode (standby state), the switching logic circuit 39 outputs a low-level switching signal to the switch part 37a and the interruption circuit 35a, and a high-level switching signal to the switch part 37b and the interruption circuit 35b. As a result, the switch part 37a and the interruption circuit 35a are disconnected so as to turn off the high-speed voltage stabilization part 29a (standby state), and the switch part 37b and the interruption circuit 35b are connected so as to turn on the low-speed voltage stabilization part 29b. Consequently, the voltage applied to the gate electrode of the output transistor 25 is controlled by the low-speed voltage stabilization part 29b. The amount of current consumed by the high-speed voltage stabilization part 29a in its standby state is less than or equal to 1 μA.

When the operating modes are switched, the switching logic circuit 39 generates a period during which the high-speed voltage stabilization part 29a and the low-speed voltage stabilization part 29b, both controlling the operation of the output transistor 25, are simultaneously turned on. When the load 3 is switched from the active mode to the sleep mode, the load 3 transmits a mode switching signal to the switching logic circuit 39. As a result, the switching logic circuit 39 turns on the low-speed voltage stabilization part 29b, and after the passage of a predetermined period of time thereafter, turns off the high-speed voltage stabilization part 29a, thereby performing switching to control by the low-speed voltage stabilization part 29b. Consequently, the high-speed voltage stabilization part 29a is not selected and enters the standby state.

When the load 3 is switched from the sleep mode to the active mode, the load 3 transmits a mode switching signal to the switching logic circuit 39. As a result, the switching logic circuit 39 turns on the high-speed voltage stabilization part 29a, and after the passage of a predetermined period of time thereafter, turns off the low-speed voltage stabilization part 29b, thereby performing switching to control by the high-speed voltage stabilization part 29a. Consequently, the low-speed voltage stabilization part 29b is not selected and enters the standby state. Thus, by generating the period of the “simultaneous ON state” at the time of switching from the low-speed voltage stabilization part 29b to the high-speed voltage stabilization part 29a and from the high-speed voltage stabilization part 29a to the low-speed voltage stabilization part 29b, it is possible to prevent noise resulting from a great variation in the output Vout at the time of switching.

In some cases, however, a certain degree of load transient response and supply voltage variation response (response to supply voltage variation) is required even in the sleep mode, although not as much as in the active mode. The operational amplifier 33b of the low-speed voltage stabilization part 29b employed in the conventional technology reduces current consumption at the sacrifice of response speed. Further, the current supply capacity of the output-stage buffer transistor of the operational amplifier 33b is also reduced. Controlling the output transistor 25, having such a large gate area as to be able to control large current, by such an operational amplifier results in extremely slow response speed. Although the operation amplifier 33b is of the low-speed voltage stabilization part 29b, its current consumption cannot be reduced significantly if a certain degree of response speed is to be ensured.

Further, the two changeover switches (the switch parts 37a and 37b) are required to switch an output to be connected to the gate of the output transistor 25 between the outputs of the two operational amplifiers 33a and 33b, thus resulting in a complicated circuit. Furthermore, when current has been continuously supplied to the load 3 at the time of switching, the driver (output transistor 25) is controlled by the operation of the high-speed voltage stabilization part 29a having a large current supply capacity. Accordingly, a relatively high level of noise may be generated during a certain period of transition of the high-speed voltage stabilization part 29a from an OFF state to a stably operating state.

### DISCLOSURE OF THE INVENTION

Accordingly, it is a general object of the present invention to provide a constant voltage power supply in which the above-described disadvantages are eliminated.

A more specific object of the present invention is to provide a constant voltage power supply that can be free of the complication of the conventional constant voltage power supply and can improve load transient response and supply voltage variation response in a standby mode without increasing current consumption.

The above objects of the present invention are achieved by a constant voltage power supply for supplying power to a load that switches between an active state and a standby state, which includes a first constant voltage circuit configured to apply a reference voltage to a first input terminal of a first operational amplifier, apply a voltage obtained by dividing an output voltage to a second input terminal of the first operational amplifier, and control a first output transistor by an output of the first operational amplifier; a second constant voltage circuit configured to apply a reference voltage to a first input terminal of a second operational amplifier, apply a voltage obtained by dividing an output voltage to a second input terminal of the second operational amplifier, and control a second output transistor by an output of the second operational amplifier, the second constant voltage circuit being configured to be inferior in transient response to and consume less current than the first constant voltage circuit; and a switching signal generation circuit configured to transmit a switching signal in accordance with the state of the load, wherein an input of each of the first and second constant voltage circuits is connected to an input terminal of the constant voltage power supply, and an output of each of the first and second constant voltage circuits is connected to an output terminal of the constant voltage power supply; and the switching signal generation circuit outputs the switching signal to cause the first operational amplifier to operate when the load is in the active state, and outputs the switching signal to cause the second operational amplifier to operate when the load is in the standby state.

According to one aspect of the present invention, a first constant voltage circuit that consumes a large amount of current but has excellent ripple rejection and load transient response and a second constant voltage circuit that is inferior in ripple rejection and load transient response but consumes less current are connected in parallel. The first constant voltage circuit is caused to operate when a load is in an active state, and the second constant voltage circuit is caused to operate when the load is in a standby state. As a result, it is possible to improve current consumption by the power supply circuit when the load is in the standby state. Further, the output transistor of the second constant voltage circuit is reduced in size. Accordingly, there is no significant decrease in response, which can be much better than conventionally. Moreover, since the output transistor of the second constant voltage circuit is reduced in size, it is possible to prevent an increase in IC chip area.

### BRIEF DESCRIPTION OF THE DRAWINGS

Other objects, features and advantages of the present invention will become more apparent from the following detailed description when read in conjunction with the accompanying drawings, in which:

FIG. 1 is a circuit diagram illustrating a conventional constant voltage power supply;

FIG. 2 is a circuit diagram illustrating a constant voltage power supply according to an embodiment of the present invention; and

FIG. 3 is a timing chart for illustrating mode switching according to the embodiment of the present invention.

### BEST MODE FOR CARRYING OUT THE INVENTION

A description is given below, with reference to the accompanying drawings, of an embodiment of the present invention.

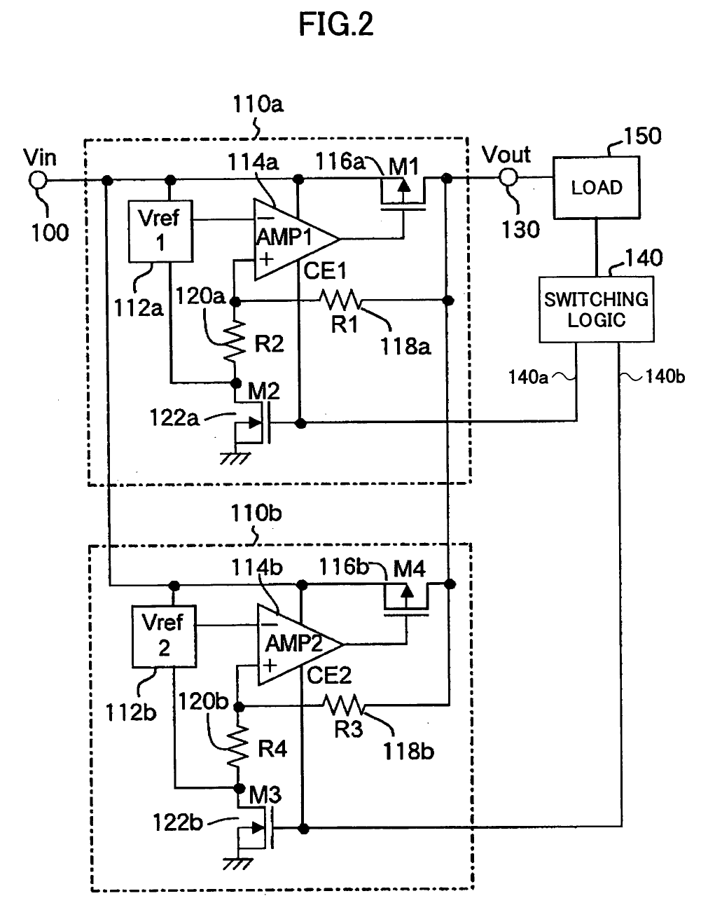

FIG. 2 is a circuit diagram illustrating a constant voltage power supply according to the embodiment of the present invention. The constant voltage power supply includes a first (high-speed) constant voltage circuit 110a and a second (low-speed) constant voltage circuit 110b, each of which converts an input voltage (Vin) into a predetermined voltage and outputs the predetermined voltage. The inputs of the first and second constant voltage circuits 110a and 110b are connected in parallel to an input terminal (Vin) 100, and the outputs of the first and second voltage circuits 110a and 110b are connected in parallel to an output terminal (Vout) 130. A power supply such as a battery (not graphically illustrated) is connected to the input terminal 100 of the constant voltage power supply. Further, a load 150 that is an apparatus such as a cellular phone is connected to the output terminal 130. The load 150 has an active mode (an active state) and a sleep mode (a standby state).

The first constant voltage circuit 110a includes a reference voltage part 112a generating a reference voltage (Vref1) (the reference voltage part 112a is also indicated as Vref1 in FIG. 2 for convenience of graphical representation), an operational amplifier (AMP1) 114a, an output transistor (M1) 116a, two resistors (R1 and R2) 118a and 120a for output voltage detection, and an n-channel MOS transistor (M2) 122a. The input terminal 100 is connected to the output terminal 130 through the output transistor 116a composed of a p-channel MOS transistor. The reference voltage part 112a includes a Zener diode. Power to the operational amplifier 114a and the reference voltage part 112a is supplied from the input terminal 100. The n-channel MOS transistor 122a serving as an interruption circuit (a switching circuit) that performs ON/OFF control of through current is provided between ground and each of the operational amplifier 114a, the reference voltage part 112a, and the ground-side terminal of the resistor 120a. The n-channel MOS transistor 122a is turned ON to allow the through current to flow, and is turned OFF to interrupt the through current. The reference voltage Vref1 is applied to the inverting input (−) of the operational amplifier 114a. A divided voltage obtained by dividing the output voltage Vout between the detection resistors 118a and 120a is applied to the non-inverting input (+) of the operational amplifier 114a. The output of the operational amplifier 114a is connected to the gate of the output transistor 116a.

The second constant voltage circuit 110b includes a reference voltage part 112b generating a reference voltage (Vref2) (the reference voltage part 112b is also indicated as Vref2 in FIG. 2 for convenience of graphical representation), an operational amplifier (AMP2) 114b, an output transistor (M4) 116b, two resistors (R3 and R4) 118b and 120b for output voltage detection, and an n-channel MOS transistor (M3) 122b. The input terminal 100 is connected to the output terminal 130 through the output transistor 116b composed of a p-channel MOS transistor.

A switching logic circuit (SWITCHING LOGIC) 140 (a switching signal generation circuit) outputs a first switching signal 140a and a second switching signal 140b to the first and second constant voltage circuits 110a and 110b, respectively, in accordance with the state of the load 150. The first switching signal 140a is input to the gate of the n-channel MOS transistor 122a and the chip-enabling terminal (CE1) of the operational amplifier 114a so as to control the operation of the first constant voltage circuit 110a. The second switching signal 140b is input to the gate of the n-channel MOS transistor 122b and the chip-enabling terminal (CE2) of the operational amplifier 114b so as to control the operation of the second constant voltage circuit 110b.

The first and second constant voltage circuits 110a and 110b have the same configuration and operate in the same manner. The first and second constant voltage circuits 110a and 110b are connected in parallel. The second constant voltage circuit 110b is configured so as to be inferior in transient response to but consume less current than the first constant voltage circuit 110a. Therefore, the transistors forming the second constant voltage circuit 110b have a smaller current supply capacity than those employed in the first constant voltage circuit 110a. Accordingly, the second constant voltage circuit 110b has lower response speed than the first constant voltage circuit 110a. The first constant voltage circuit 110a consumes a large amount of current, but has excellent PSRR or ripple rejection and load transient response. The second constant voltage circuit 110b is inferior in ripple rejection and load transient response, but consumes less current.

The switching logic circuit 140 transmits the first and second switching signals 140a and 140b to the first and second constant voltage circuits 110a and 110b, respectively, in accordance with the state of the load 150 so that the first operational amplifier 114a operates when the load 150 is in the active state and the second operational amplifier 114b operates when the load 150 is in the standby state. Thus, the operations of the two constant voltage circuits 110a and 110b different in transient response and current consumption are switched.

When the first switching signal 140a transmitted to the first constant voltage circuit 110a by the switching logic circuit 140 is at high level (HIGH), the n-channel MOS transistor 122a is turned ON, and the operational amplifier 114a operates to control the gate voltage of the output transistor 116a so that the two input voltages to the operational amplifier 114a are equalized. Accordingly, the output voltage of the first constant voltage circuit 110a is output to the output terminal 130 of the constant voltage power supply.

On the other hand, when the first switching signal 140a is at low level (LOW), the n-channel MOS transistor 122a is turned OFF, so that the supplying of power to the reference voltage part 112a and the detection resistors 118a and 120a is stopped. Further, the operational amplifier 114a is stopped, and the output voltage of the operational amplifier 114a is set to high level so that the output transistor 116a is turned OFF.

Likewise, when the second switching signal 140b transmitted to the second constant voltage circuit 110b by the switching logic circuit 140 is HIGH, the output voltage of the second constant voltage circuit 110b is output to the output terminal 130 of the constant voltage power supply. Further, when the second switching signal 140b is LOW, the output transistor 116b is turned OFF.

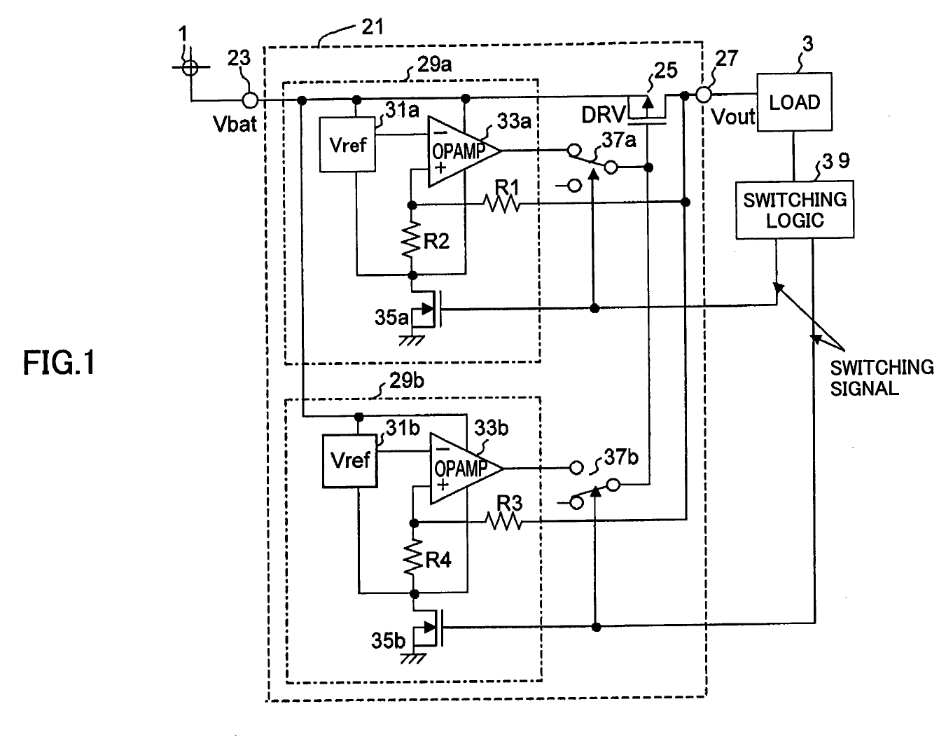

The response speed of the second constant voltage circuit 110b is compared with that of the conventional constant voltage circuit (FIG. 1). If the transistors employed in the operational amplifier 114b and the conventional operational amplifier 33b have the same current supply capacity, the operational amplifiers 114b and 33b are equal in response speed. However, the current supply capacity of the output transistor 116b of the second constant voltage circuit 110b is smaller in current by three or four digits than that of the output transistor 116a of the first constant voltage circuit 110a. Accordingly, the output transistor 116b can be extremely small in size.

Specifically, the device size ratio of the output transistor 116a of the first constant voltage circuit 110a to the output transistor 116b of the second constant voltage circuit 110b was set to be greater than or equal to the drive current ratio of the operational amplifier 114a of the first constant voltage circuit 110a to the operational amplifier 114b of the second constant voltage circuit 110b. In this case, the gate-source capacitance, the gate-bulk capacitance, and the gate-drain capacitance of the output transistor 116b are extremely small compared with those of the output transistor 116a. Accordingly, although the drive capability of the operational amplifier 114b is low, there is no significant reduction in response speed. As a result, the response speed of the second constant voltage circuit 110b was dramatically improved compared with that of the combination of the low-speed voltage stabilization part 29b and the output transistor 25 of the conventional constant voltage power supply of FIG. 1.

In the conventional constant voltage circuit 21 of FIG. 1, a large-size output transistor is required in the case of connecting two power supply circuits in parallel, thus increasing the chip area of an IC. On the other hand, according to the embodiment of the present invention, the load current of the second constant voltage circuit 110b is used only in the standby state where only approximately 1 μA to 1 mA of current flows. Accordingly, the output transistor 116b can be extremely small in size. Therefore, there is no need to increase the area of the IC chip. Further, according to the embodiment of the present invention, the switch parts 37a and 37b employed in the conventional constant voltage circuit 21 of FIG. 1 are unnecessary. Accordingly, it is possible to simplify the circuit.

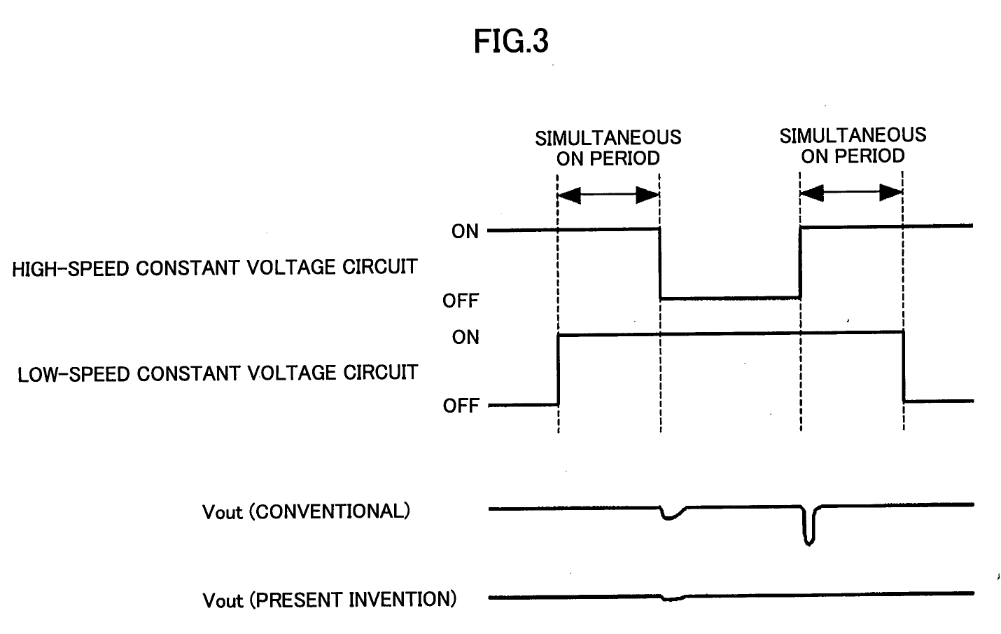

FIG. 3 is a timing chart for illustrating mode switching. The switching logic circuit 140 outputs the first and second switching signals 140a and 140b at the time of mode switching so that a period of time during which the first and second constant voltage circuits 110a and 110b operate simultaneously is provided. This period, which may be referred to as a “simultaneous ON period,” is set to be greater than the output voltage rising period of each of the first and second constant voltage circuits 110a and 110b.

In the conventional constant voltage power supply of FIG. 1, when current has been continuously supplied to the load 3 at the time of mode switching, the driver (output transistor 25) is controlled by the operation of the high-speed voltage stabilization part 29a having a large current supply capacity. Accordingly, a relatively high level of noise may be generated during a certain period of transition of the high-speed voltage stabilization part 29a from an OFF state to a stable operating state. On the other hand, according to the constant voltage power supply of this embodiment, the output transistors 116a and 116b are simultaneously controlled by the different operational amplifiers 114a and 114b, respectively. Therefore, either one of the output transistors 116a and 116b always operates stably. Accordingly, it is possible to supply a load also at the time of mode switching, and therefore, it is possible to reduce noise resulting from the operational amplifier 33a having a large current supply capacity. As a result, it is possible to prevent noise generated by the operational amplifier 33a during its transition from an OFF state to a stable operating state at the time of mode switching.

According to the constant voltage power supply of this embodiment, the first constant voltage circuit 110a that consumes a large amount of current but has excellent ripple rejection and load transient response and the second constant voltage circuit 110b that is inferior in ripple rejection and load transient response but consumes less current are connected in parallel. The first constant voltage circuit 110a is caused to operate when the load 150 is in an active state, and the second constant voltage circuit 110b is caused to operate when the load 150 is in a standby state. As a result, it is possible to improve current consumption by the power supply circuit when the load 150 is in the standby state. Further, the output transistor 116b of the second constant voltage circuit 110b is reduced in size. Accordingly, there is no significant decrease in response, which can be much better than conventionally. Moreover, since the output transistor 116b of the second constant voltage circuit 110b is reduced in size, it is possible to prevent an increase in IC chip area.

Further, the operational amplifier 114a of the first constant voltage circuit 110a employs a transistor having a greater current supply capacity than that of the operational amplifier 114b of the second constant voltage circuit 110b. Accordingly, it is possible to reduce current consumption when the load 150 is in the standby state.

Further, the output transistor 116b is smaller in device size and current supply capacity than the output transistor 116a. Accordingly, it is possible to control a decrease in response performance.

Further, the device size ratio of the output transistor 116a to the output transistor 116b is set to be greater than or equal to the drive current ratio of the operational amplifier 114a to the operational amplifier 114b. Accordingly, it is possible to control a decrease in response performance.

Further, the first and second constant voltage circuits 110a and 110b operate simultaneously when the state of the load 150 switches. Accordingly, it is possible to control noise when one of the first and second constant voltage circuits 110a and 110b switches to the other.

Further, the interruption circuits 122a and 122b that interrupt through current are provided. Accordingly, it is possible to further reduce current consumption when one of the first and second constant voltage circuits 110a and 110b is not selected.

Further, when the state of the load 150 switches, there is a period of time during which both of the operational amplifiers 114a and 114b operate and both of the interruption circuits 122a and 122b are turned on. Accordingly, it is possible to control noise when one of the first and second constant voltage circuits 110a and 110b switches to the other.

The present invention is not limited to the specifically disclosed embodiment, and variations and modifications may be made without departing from the scope of the present invention.

The present application is based on Japanese Priority Patent Application No. 2003-433774, filed on Dec. 26, 2003, the entire contents of which are hereby incorporated by reference.

1. A constant voltage power supply for supplying power to a load that switches between an active state and a standby state, comprising:
a first constant voltage circuit configured to apply a reference voltage to a first input terminal of a first operational amplifier, apply a voltage obtained by dividing an output voltage to a second input terminal of the first operational amplifier, and control a first output transistor by an output of the first operational amplifier;
a second constant voltage circuit configured to apply a reference voltage to a first input terminal of a second operational amplifier, apply a voltage obtained by dividing an output voltage to a second input terminal of the second operational amplifier, and control a second output transistor by an output of the second operational amplifier, the second constant voltage circuit being configured to be inferior in transient response to and consume less current than the first constant voltage circuit; and
a switching signal generation circuit configured to transmit a switching signal in accordance with the state of the load,
wherein an input of each of the first and second constant voltage circuits is connected to an input terminal of the constant voltage power supply, and an output of each of the first and second constant voltage circuits is connected to an output terminal of the constant voltage power supply; and
the switching signal generation circuit outputs the switching signal to cause the first operational amplifier to operate when the load is in the active state, and outputs the switching signal to cause the second operational amplifier to operate when the load is in the standby state.

2. The constant voltage power supply as claimed in claim 1, wherein:
the first and second operational amplifiers are equal in circuit configuration; and
the first operational amplifier employs a transistor greater in current supply capacity than that of the second operational amplifier.

3. The constant voltage power supply as claimed in claim 1, wherein the second output transistor is smaller in device size and current supply capacity than the first output transistor.

4. The constant voltage power supply as claimed in claim 3, wherein a device size ratio of the first output transistor to the second output transistor is greater than or equal to a drive current ratio of the first operational amplifier to the second operational amplifier.

5. The constant voltage power supply as claimed in claim 1, wherein when the load switches from one to the other of the active and standby states, the switching signal generation circuit outputs the switching signal so that there is a period of time during which the first and second constant voltage circuits operate simultaneously.

6. The constant voltage power supply as claimed in claim 1, wherein:
each of the first and second constant voltage circuits includes a switching circuit configured to be turned on to allow through current to flow and be turned off to interrupt the through current; and
the switching circuit of the first constant voltage circuit is turned on and the switching circuit of the second constant voltage circuit is turned off when the load is in the active state, and the switching circuit of the first constant voltage circuit is turned off and the switching circuit of the second constant voltage circuit is turned on when the load is in the standby state.

7. The constant voltage power supply as claimed in claim 6, wherein when the load switches from one to the other of the active and standby states, the switching signal generation circuit outputs the switching signal so that there is a period of time during which the first and second operational amplifiers operate and the switching circuits of the first and second constant voltage circuits are turned on.
